(19) United States
(12) Patent Application Publication
(10) Pub. No.: US 2006/0265291 A1
(43) Pub. Date: Nov. 23, 2006

(54) Method and system using moving images for conducting electronic commerce

(76) Inventors: Noah Axler, Maple Glen, PA (US); Christopher Hennessy, Berkeley, CA (US); Nicole Axler, Maple Glen, PA (US)

Correspondence Address: RATNERPRESTIA, P O BOX 980, VALLEY FORGE, PA, 19482-0980, US

(21) Appl. No.: 11/132,548

(22) Filed: May 19, 2005

(51) Int. Cl. G07F 7/00; G06Q 30/00

(52) U.S. Cl. 705/27; 705/26

(57) ABSTRACT

A method and system using moving images for conducting electronic commerce are disclosed. A moving image is displayed that contains links to one or more additional image sources. The additional sources contain information about goods or services related to the moving image.

### FIELD OF THE INVENTION

The invention is in the field of electronic commerce. More specifically, the invention relates to methods for enabling users of electronic media visual displays to engage in automated commerce and the purchase of goods and services through links embedded in moving images.

### BACKGROUND OF THE INVENTION

Placement of links allowing automated commerce and purchasing through electronic media visual displays is described in U.S. Pat. No. 6,266,650 to Sugaya et al. and PCT published application WO 00/72179 A2. These disclose systems and methods in which merchandise catalogues are represented in electronic still images.

These documents do not disclose the use of links embedded in full-motion moving images, however. The inventive method allows users of electronic media visual displays to select links embedded in moving images that will enable the electronic media visual display user to gain access to an internet address or other electronic location where the user may obtain information about goods or services related to the moving image and, if desired, purchase these goods or services.

The method of embedding links in dynamic images which allow access to an internet address or other electronic location for the purpose of purchasing goods and services departs from the inventional concepts and design of the prior art, and in so doing provides a method primarily developed for the purpose of allowing users of electronic media visual displays to engage in automated commerce and the purchase of goods and services through links embedded in moving images.

### BRIEF DESCRIPTION OF THE INVENTION

A moving image is displayed which contains links to a second image source. The supplier of the moving image might be a vendor desiring to advertise and sell particular items, such as clothing. The moving image might be distributed in the form of a digital video disc (DVD), a broadcast over cable or over the air, or over the internet, as examples.

The links are connected with certain specific images within the scenes of the moving image. A viewer may watch the moving image on a screen and notice certain specific images of items of interest, such as an article of clothing being worn by a person in the scene. Using a pointing device, the viewer can designate and select the specific image, activating the link connected with that specific image. The activation brings one or more images from the second image source to the screen for viewing by the viewer. These new images may themselves contain links to each other, to other images from the second source, and back to the moving image, allowing the viewer to navigate between all of these images. The new second-source images may include additional information about the item in the specific image selected from the moving image. They may also enable the user to place a purchase order for the item.

### BRIEF DESCRIPTION OF THE DRAWINGS

FIG. 1 shows a schematic of an embodiment of a system in which the method is implemented.

FIG. 2 shows a flow chart indicating an embodiment of the method.

### DETAILED DESCRIPTION OF THE INVENTION

The following detailed descriptions of embodiments of the invention are to be construed as examples and not as limiting to the scope of the invention.

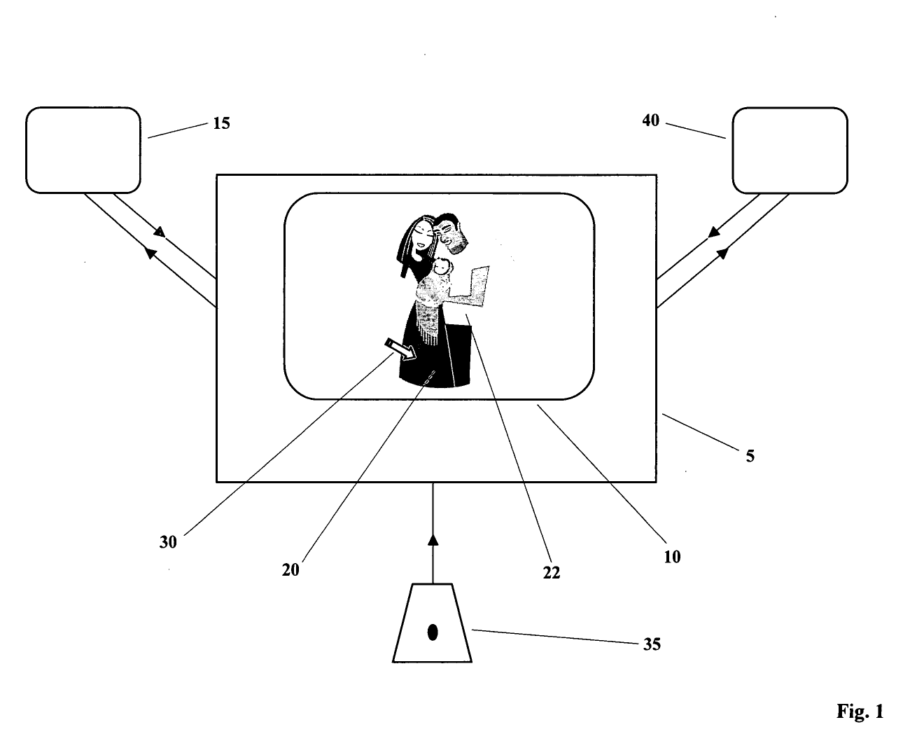

FIG. 1 depicts one embodiment of the method. A viewing system 5 comprises a screen 10 and hardware and software capable of receiving, processing, and acting on information from one or more information sources, such as a pointing device 35, a first image source 15 and a second image source 40. A viewer views a moving image on the screen 10, which originates from the first image source 15, such as a DVD being played in a local DVD player. The DVD might contain, for example, a movie in video form (viewable on a TV) produced by a clothing manufacturer and the DVD could be distributed by traditional mail. Alternatively, the first source could be a broadcast over the air or via a solid conduit, such as a wire, cable, waveguide, or optical fiber.

Within a scene of this moving image are specific images of one or more items 20, 22, such as articles of clothing being worn by people in the scene. The viewer, desiring either to purchase an item or to learn more about the item before making a purchasing decision, designates the specific image of the item 20 by moving a cursor 30 over that specific image 20 through the use of the pointing device 35. The viewer then selects the item by, for example, pushing a button on the pointing device 35.

The act of selecting the item may stop the moving image and cause one or more images from a second source 40 to appear on the screen 10. Alternatively, the viewer might stop the moving image—pause or “freeze” a frame—before designating and selecting an item in the resulting still image. The image from the second source 40 conveys to the viewer further information concerning the selected item 20. The second source 40 image may contain links to other second source images, which again might provide additional information. To view these other images, the viewer could use the pointing device 35 to designate and select a particular area of the present second source 40 image. One of these second source 40 images could be in the form of a purchase order, which the viewer could fill out, using the pointing device, and then send to a supplier by selecting another link, thereby purchasing the item. The second-source 40 images could also contain links, which enable the viewer to return to the first source moving image at any time by selecting those links. After so returning, the viewer could then repeat the process by designating and selecting additional images 22 of other items, distinct from those previously selected.

The designating and selecting can be realized in numerous ways. In one embodiment the pointing device 35 might operate in the manner of a mouse for a personal computer. Designating may be accomplished by moving the pointing device 35, thereby moving a cursor 30 to the desired area of the image 20, 22. Selecting of that area may then be done by pushing a button, or “clicking.” The pointing device 35 may interact with the viewing system 5 either through a wired or a wireless connection. Wireless connections could be accomplished with a beam emitted from the pointing device 35 and detected somewhere at the viewing system 5. The beam might be electromagnetic (radio or infrared) or acoustic.

The second source 40 of images could be provided by a warehouse, distribution center, manufacturing center, catalogue center or order processing center. It may be linked to the viewing system in various ways, and the linking of the second source images to each other can likewise be realized in various ways. These moving image frames and second-source images may contain embedded Universal Resource Locators (URLs) and the linking can be accomplished through the Internet to a website. Alternatively, the linking could be accomplished through a direct radio frequency (RF) link, either through a ground-based channel or a satellite.

In one embodiment the viewing system may process information as follows: the first image source 15 may convey to the viewing system 5 two sets of information for each frame of the moving image. A first set is the image information, which is used by the viewing system 5 to form the image of each frame of the moving image on the screen 10. A second set conveys, for a given frame, which areas of that frame can be selected using the pointing device 35, and linking information, such as a URL, corresponding to each selectable area. Selectable areas comprise the areas of specific images 20, 22. The viewing system 5 receives both sets of information and also a third set originating with the pointing device 35. This third set contains the position of the cursor 30 and whether, at any given moment, the designated area is being selected by the viewer. The viewing system 5 compares the position of the cursor 30 and the information in the second set in order to determine whether or not the cursor is in a selectable region of the frame.

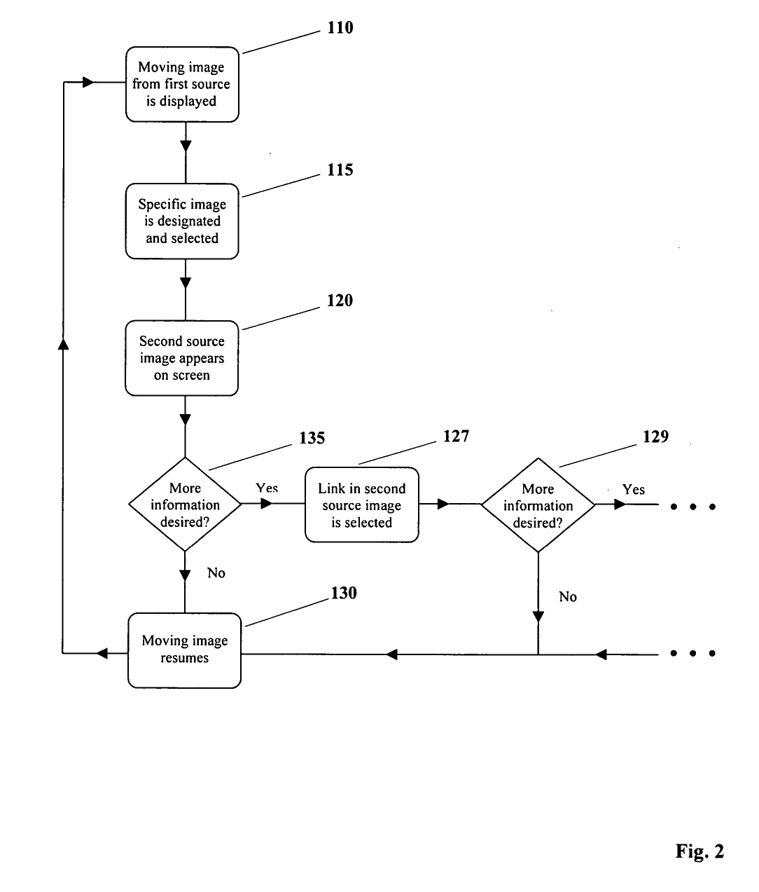

FIG. 2 shows a flowchart illustrating an embodiment of the method. This embodiment, including the temporal order of the events depicted, is for illustration only and is not to be construed as limiting the scope of the invention.

A moving image from the first source 15 is displayed 110 by the viewing system 5. At some point a viewer sees a specific image of an object in the frame and wants to learn more about it and perhaps ultimately purchase it. The viewer designates and selects 115 the object using the pointing device 35. An image from the second source 40 now appears 120 on the screen 10. The viewer now examines the second source image and then makes a choice 135 to either view a new second source image 127 or to return to the first source moving image 130. After viewing 127 any succeeding second-source image the viewer once again has a choice 129 of either viewing another second source image or returning to the moving image 130.

In one embodiment, linking information might be encoded in a moving image as follows: The first image source 15 could be a recording medium, such as a DVD, containing multiple discrete frames which, when displayed sequentially, form a moving image. For each frame, the medium also contains information encoding which portions of that frame define the specific images 20, 22 that can be selected by the pointing device 35. One example of such a selectable portion might be an article of clothing worn by a person in the frame.

Before the displaying of a given frame, the specific image area information for that frame is transmitted from the first image source 15 to the viewing system 5. This transmission may occur in a time interval between the displaying of the given frame and the displaying of the previous frame. Also transmitted is the linking information associated with each specific image, such as a URL. The information for the display of the entire frame is transmitted and displayed on the screen 10. The position of the cursor 30, determined by the pointing device, is loaded. The cursor position and the specific image location information are compared to determine whether or not the cursor is within a specific image area 20, 22—i.e. to determine if that specific image area is being designated. If it is, and if the specific image is being selected, the moving image is stopped, the linking information is read, and communication with the second image source 40 is initiated. If a specific image 20,22 is not being designated or selected, the specific image information for the next frame is loaded, followed by the frame information itself, and the cycle repeats for the duration of the moving image presentation. Once the viewer is finished with images from the second source, the viewer can return to the moving image as previously described.

The preceding descriptions and embodiments are for illustrative purposes only, and should not be construed as limiting the scope of the invention. The scope of the invention is to be determined by the following claims.

What is claimed is:

1. A method of electronic commerce, the method comprising:
displaying a moving image from a first source on a viewing system comprising a screen and pointing device, at least some scenes in said moving image comprising images of one or more items;
designating one or more specific images of said one or more items using said pointing device;
selecting said one or more specific images using said pointing device, said selecting resulting in linking to one or more images from a second source, and;
displaying said one or more images from said second source on said screen, said one or more images comprising information pertaining to the items in said selected one or more specific images.

2. The method of claim 1, wherein navigation among said second source images and back to said moving image is accomplished by designating and selecting portions within said second-source images with said pointing device.

3. The method of claim 2, wherein a moving image from either of said sources is halted, said designating and selecting from either source being carried out on a resulting still image.

4. The method of claim 1, further comprising the purchasing of one or more of said items, said purchasing being initiated by designating and selecting said one or more specific images.

5. The method of claim 1 further comprising designating and selecting additional images of said items in said moving image, distinct from said one or more specific images.

6. The method of claim 1, wherein said moving image is a video image.

7. The method of claim 1, wherein said moving image is conveyed to said viewing system using the internet.

8. The method of claim 1, wherein said first source is a DVD.

9. The method of claim 8, wherein said DVD is played locally.

10. The method of claim 1, wherein said first source is a broadcast.

11. The method of claim 10, wherein said broadcast is through the air.

12. The method of claim 10, wherein said broadcast is through a solid conduit.

13. The method of claim 12, wherein said conduit is selected from the group consisting of wire, cable, waveguide, and optical fiber.

14. The method of claim 1, wherein said designating and selecting are accomplished with a cursor appearing on said screen, said cursor being controlled by said pointing device.

15. The method of claim 1, wherein said designating and selecting are accomplished with a beam emitted from said pointing device and propagated wirelessly.

16. The method of claim 15, wherein said beam comprises an electromagnetic wave.

17. The method of claim 15, wherein said beam comprises an acoustic wave.

18. The method of claim 1, wherein said linking to said second-source images comprises the use of a URL.

19. The method of claim 1, wherein at least some of said second-source images are linked by URL's.

20. The method of claim 1, wherein said linking is accomplished through the Internet.

21. The method of claim 1, wherein said linking is accomplished through a direct RF link.

22. The method of claim 21, wherein said direct RF link is established through a satellite.

23. The method of claim 21, wherein said direct RF link is established through a ground-based channel.

24. The method of claim 1, wherein said second source is provided by one or more of a warehouse, distribution center, manufacturing center, catalogue center or order processing center.

25. The method of claim 1, wherein said second source is a website.

26. The method of claim 1, wherein said moving image comprises multiple discrete frames sequentially displayed on said screen, said first source transmitting to said viewing system the locations of said one or more specific images within a given frame, said transmitting occurring before the displaying of said given frame.

27. The method of claim 26, said transmitting of locations occurring during a time interval between the displaying of said given frame and the displaying of the previous frame.

28. The method of claim 26, wherein said viewing system compares said locations with the location of designation from said pointing device to determine if said one or more specific images is being designated.

29. A system for electronic commerce, the system comprising:
a viewing system comprising a screen and a pointing device,
a first image source, and
a second image source,
wherein said first source provides:
a moving image to said viewing system, at least some scenes in said moving image comprising images of one or more items, and
links connecting said images of one or more items to one or more images from said second source;
wherein designating and selecting with said pointing device one or more specific images from said images of one or more items results in activating said links and displaying said one or more images from said second source on said screen, said one or more images comprising information pertaining to the items in said selected one or more specific images.

30. The system of claim 29, wherein navigation among said second source images and back to said moving image is accomplished by designating and selecting portions within said second-source images with said pointing device.

31. The system of claim 30, wherein said navigation comprises the use of URLs.

32. The system of claim 29, wherein the purchasing of said one or more items can be initiated by designating and selecting said images of one or more items.

33. The system of claim 29, wherein said moving image is a video image.

34. The system of claim 29, wherein said moving image is conveyed to said viewing system using the internet.

35. The system of claim 29, wherein said first source is a DVD.

36. The system of claim 35, wherein said DVD is played locally.

37. The system of claim 29, wherein said first source is a broadcast said broadcast being either through the air or through a solid conduit.

38. The system of claim 37, wherein said conduit is selected from the group consisting of wire, cable, waveguide, and optical fiber.

39. The system of claim 29, wherein said designating and selecting are accomplished with a cursor appearing on said screen, said cursor being controlled by said pointing device.

40. The system of claim 29, wherein said designating and selecting are accomplished with a beam emitted from said pointing device and propagated wirelessly.

41. The system of claim 40, wherein said beam comprises either an electromagnetic wave or an acoustic wave.

42. The system of claim 29, wherein said links comprise the use of URLs.

43. The system of claim 29 wherein said links are accomplished through the internet.

44. The system of claim 29 wherein said links are direct RF links.

45. The system of claim 44, wherein said direct RF links are established through a satellite.

46. The system of claim 44, wherein said direct RF links are established through a ground-based channel.

47. The system of claim 29, wherein said second source is provided by one or more of a warehouse, distribution center, manufacturing center, catalogue center or order processing center.

48. The system of claim 29, wherein said second source is a website.

49. The system of claim 29, wherein said moving image comprises multiple discrete frames sequentially displayed on said screen, said first source transmitting to said viewing system the locations of said one or more specific images within a given frame, said transmitting occurring before the displaying of said given frame.

50. The system of claim 49, said transmitting of locations occurring during a time interval between the displaying of said given frame and the displaying of the previous frame.

51. The system of claim 49, wherein said viewing system compares said locations with the location of designation from said pointing device to determine if said one or more specific images is being designated.

52. The system of claim 30, wherein a moving image from either of said sources can be halted, said designating and selecting from either source being carried out on a resulting still image.
